(19) United States
(12) Patent Application Publication
(10) Pub. No.: US 2018/0031035 A1
(43) Pub. Date: Feb. 1, 2018

(54) An Automobile Air Conditioning Compressor

(71) Applicant: FOSHAN GUANG DONG AUTOMOTIVE AIR CONDITIONING CO., LTD, FOSHAN (CN)

(72) Inventor: Wenqing Li, FOSHAN (CN)

(73) Assignee: FOSHAN GUANG DONG AUTOMOTIVE AIR CONDITIONING CO., LTD, FOSHAN (CN)

(21) Appl. No.: 15/325,587

(22) PCT Filed: Feb. 1, 2016
(86) PCT No.: PCT/CN2016/073057

§ 371 Date: Jan. 11, 2017

(51) Int. Cl. F16C 19/46; F16C 33/58; F04B 53/00

(52) U.S. Cl. CPC F16C 19/46; F04B 53/006; F16C 33/58; F16C 2360/42

(57) ABSTRACT

An automotive air conditioning compressor includes a crankshaft, a shell, an end cover, a rear balance block, a front balance block, a belleville spring, a thrust bearing, a rear rolling bearing, and a front rolling bearing.

### FIELD OF THE INVENTION

The present disclosure relates to the technical field of compressor, particularly to an automotive air conditioning compressor.

### BACKGROUND OF THE INVENTION

The operating principle of the compressor is described as below. The rotation of the compressor crankshaft 1 will put the piston in upper and lower radial linear motion to realize the suction and exhaust of air. However, in the prior art, as shown in FIG. 1, the axial fixation of the crankshaft 1 is to connect the thrust washer 2 and the belleville spring 3 between the balance block and the shell to keep the crankshaft 1 from axial movement with the force of deformation of the belleville spring 3. By applying the prior arts above, the compressor is easy to break down with a short service life. After dissection, identification, research and analysis, it is found out that during the rotation of crankshaft 1, the thrust pad 2 will rotate together with the crankshaft 1. The friction of contact surface caused by the relative movement of the thrust pad 2 and the aluminum alloy end face of the shell will wear the end face and produce metal debris which can cause serious damage on the compressor piston and the surface of other parts. Meanwhile, the abrasion of the compressor shell will cause the increase of the axial clearance of principal axis and the compressor will be stuck. The above-mentioned reasons seriously reduce the service performance and shorten the service life of the compressor.

### SUMMARY OF THE INVENTION

The present invention is aimed to provide an automotive air conditioning compressor with improved axial fixation of crankshaft and no abrasion of shell.

To achieve the above objective, the technical solution is described as below.

An automotive air conditioning compressor includes the crankshaft, the shell, the end cover, the rear balance block, the front balance block, the belleville spring, the thrust bearing, the rear rolling bearing, and the front rolling bearing. The said shell is connected with the said end cover; the said shell is connected with the outer diameter of the said rear rolling bearing; the rear main journal of the said crankshaft is connected with the inner diameter of the said rear rolling bearing; the outer diameter of the said front rolling bearing is connected with the said end cover; the front main journal of the said crankshaft is connected with the inner diameter of the said front rolling bearing; the outer end faces of the two crank arms of the rod journal of the said crankshaft are respectively connected with the said rear and front balance blocks; the outer side of the front balance block is connected with the belleville spring; between the rear balance block and the shell or between the belleville spring and the end cover, at least one of which is connected with a thrust bearing.

Further, wherein a thrust bearing is connected between the said rear balance block and the said shell or between the said belleville spring and the said end cover.

Further, wherein the said thrust bearing is a single direction ball thrust bearing.

Further, wherein the said thrust bearing can be a single direction cylindrical roller thrust bearing.

Further, wherein the said thrust bearing can also be a single direction needle roller thrust bearing.

Further, wherein the hardness of the needle roller of the said single direction needle roller thrust bearing is 60HRC˜65HRC, 62HRC is preferred. The surface roughness Ra of the washer raceway is 0.15 μm˜0.2 μm, 0.18 μm is preferred. The hardness of the washer is 60HRC˜65HRC , 62HRC is preferred.

Adopting the above mentioned technical solution, because of the combination of the thrust bearing and the belleville spring for compressor axial fixation, even though there will be an pressure on the thrust bearing during the operation of the crankshaft that drives the bearing washer of the thrust bearing to rotate together, it will not cause the movement of the bearing washers between the thrust bearing and the contact face of the compressor shell and the end cover to wear the contact face of the compressor and the end cover. Without metal debris resulted from abrasion, the technical solution efficiently improves the operating environment for the components such as the compressor piston and increases the service life of the compressor components. Meanwhile the axial clearance of the compressor crankshaft will not increase so that the compressor will not be stuck during operation. Therefore the present automotive air conditioning compressor has strong potential market competitiveness with better operating performance, longer service life and better economic benefits.

### BRIEF DESCRIPTION OF THE DRAWINGS

FIG. 1 is the sectional view of the automotive air conditioning compressor adopting the thrust washer in the technical field of prior art;

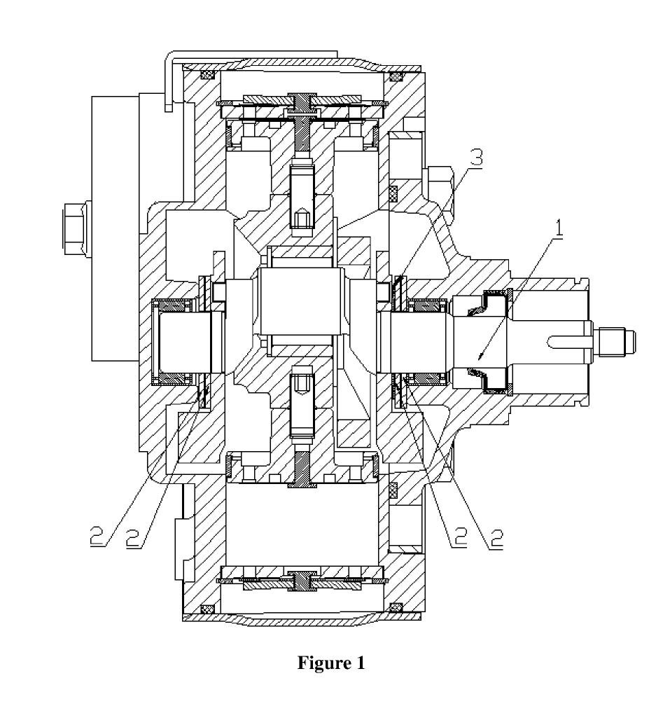

FIG. 2 is the sectional view of the invention;

FIG. 3 is the partial exploded view of the Part I in FIG. 2.

### DETAILED DESCRIPTION

The preferred embodiments of the present invention will be described in further details with reference to the accompanying drawings. It is to be noted that the description of the embodiments is to help the understanding of the present invention, but not to limit the invention. Besides, the technical features involved in the various embodiments of the present invention described below may be combined with each other as long as they do not conflict with each other.

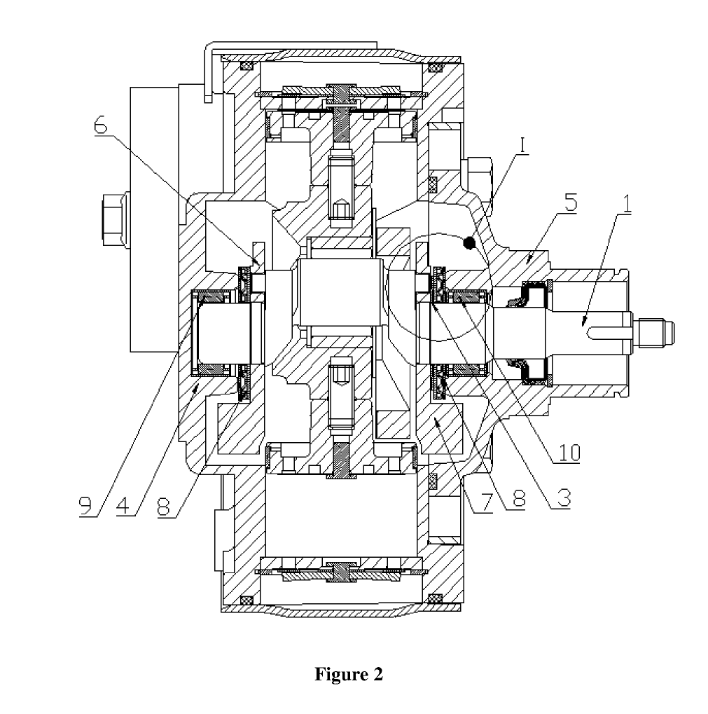

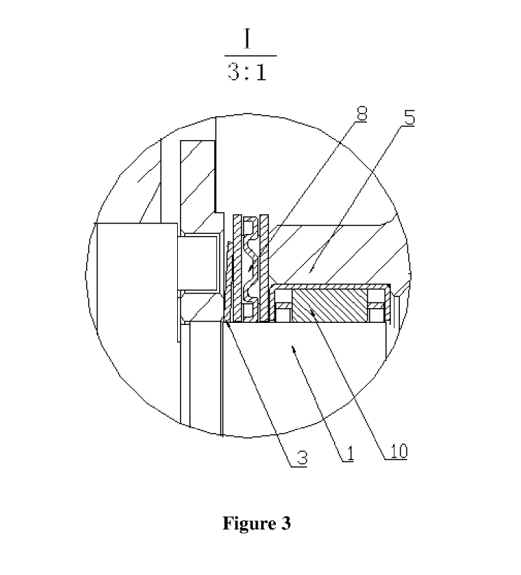

As shown in FIG. 2 and FIG. 3, an automotive air conditioning compressor includes the crankshaft 1, the belleville spring 3, the shell 4, the end cover 5, the rear balance block 6, the front balance block 7, the thrust bearing 8, the rear rolling bearing 9, and the front rolling bearing 10. The shell 4 is connected with the end cover 5; the shell 4 is connected with the outer diameter of the rear rolling bearing 9; the rear main journal of the crankshaft 1 is connected with the inner diameter of the rear rolling bearing 9; the outer diameter of the front rolling bearing 10 is connected with the end cover 5; the front main journal of the crankshaft 1 is connected with the inner diameter of the front rolling bearing 10; the outer end faces of the two crank arms of the rod journal of the crankshaft 1 are respectively connected with the rear balance block 6 and the front balance block 7; the outer side of the front balance block 7 is connected with the belleville spring 3; between the rear balance block 6 and the shell 4 or between the belleville spring 3 and the end cover 5, at least one of which is connected with a thrust bearing 8.

Because of the application of thrust bearing 8, the above mentioned technical solution efficiently decreases the abrasion of the shell 4 and end cover 5 during the rotation of the crankshaft 1, prevents the generation of the metal debris, improves the operating environment for the components, keeps the components surfaces from the damage of the metal debris and extends the service life of the compressor parts. More specifically, the thrust bearing 8 is connected between the rear balance block 6 and the shell 4, and between the belleville spring 3 and end cover 5. This technical solution completely prevents the contact face between the crankshaft 1 and the shell 4 and the end cover 5 from abrasion during the operation of the crankshaft 1, prevents the generation of metal debris, avoids the expansion of the axial clearance of the crankshaft 1, effectively eliminates the stuck of crankshaft 1 when in operation, and improves the compressor operating performance and increases the service life.

More specifically, the thrust bearing 8 can be a single direction ball thrust bearing, or a single direction cylindrical roller thrust bearing, or a single direction needle roller thrust bearing. The embodiment of the present invention adopts the single direction needle roller thrust bearing. The hardness of the needle roller of the said single direction needle roller thrust bearing is 60HRC-65HRC. The surface roughness Ra of the washer raceway is 0.15 μm-0.2 μm. The hardness of the washer is 60HRC-65HRC. In the embodiment, the hardness of the needle roller of the single direction needle roller thrust bearing is 62HRC, the surface roughness Ra of the washer raceway is 0.18 μm and the hardness of the washer is 62HRC. The rated load of the said single direction needle roller thrust bearing C a=14.1 KN with CO a=56 KN efficiently improves the performance of the thrust bearing and increases the service life and then improves the working quality, operating efficiency and service life of the compressor.

The embodiments of the present invention have been described in details with reference to the drawings, but the invention is not limited to the embodiments described above. It is well known to those skilled in the art that various changes, modifications, substitutions and alterations may be made without departing from the principles and spirit of the invention, which also fall within the scope of the invention.

1-9. (canceled)

10. An automotive air conditioning compressor comprising:
a crankshaft, a shell, an end cover, a rear balance block, a front balance block, a belleville spring, a thrust bearing, a rear rolling bearing, and a front rolling bearing;
wherein the shell is connected with the end cover; the shell is connected with the outer diameter of the rear rolling bearing; the rear main journal of the crankshaft is connected with the inner diameter of the rear rolling bearing; the outer diameter of the front rolling bearing is connected with the end cover; the front main journal of the crankshaft is connected with the inner diameter of the front rolling bearing; the outer end faces of the two crank arms of the crankshaft rod journal are respectively connected with the rear balance block and the front balance block; the outer side of the front balance block is connected with the belleville spring; and between the rear balance block and the shell or between the belleville spring and the end cover, at least one of which is connected with a thrust bearing.

11. The automotive air conditioning compressor of claim 10, wherein a thrust bearing is connected between the rear balance block and the shell, and a thrust bearing is connected between the belleville spring and the end cover.

12. The automotive air conditioning compressor of claim 10, wherein the thrust bearing is a single direction ball thrust bearing.

13. The automotive air conditioning compressor of claim 10, wherein the thrust bearing is a cylindrical roller thrust bearing.

14. The automotive air conditioning compressor of claim 10, wherein the thrust bearing is a single direction needle roller thrust bearing.

15. The automotive air conditioning compressor of claim 14, wherein the hardness of the needle roller of the single direction needle roller thrust bearing is 60HRC˜65HRC.

16. The automotive air conditioning compressor of claim 15, wherein the surface roughness Ra of the washer raceway of the single direction needle roller thrust bearing is 0.15 μm˜0.2 μm.

17. The automotive air conditioning compressor of claim 16, wherein the hardness of the washer of the single direction needle roller thrust bearing is 60HRC˜65HRC.

18. The automotive air conditioning compressor of claim 17, wherein the hardness of the needle roller of the single direction needle roller thrust bearing is 62HRC, the surface roughness Ra of the washer raceway is 0.18 μm and the hardness of the washer is 62HRC.
